(19) United States
(12) Patent Application Publication
(10) Pub. No.: US 2025/0129493 A1
(43) Pub. Date: Apr. 24, 2025

(54) HYDROGEN ELECTROLYSER SYSTEM BASED ON A WIND TURBINE GENERATOR

(71) Applicant: VESTAS WIND SYSTEMS A/S, Aarhus N (DK)

(72) Inventor: Tusitha ABEYASEKERA, Aarhus N (DK)

(21) Appl. No.: 18/689,902

(22) PCT Filed: Sep. 5, 2022
(86) PCT No.: PCT/DK2022/050177

§ 371 Date: Mar. 7, 2024

(30) Foreign Application Priority Data
Sep. 7, 2021 (DK) PA202170443

(51) Int. Cl. C25B 9/65; C25B 1/042; C25B 15/023; F03D 7/02; F03D 9/25

(52) U.S. Cl. CPC C25B 9/65; C25B 15/023; F03D 7/0224; F03D 9/25; C25B 1/042; F05B 2220/61; F05B 2220/706; F05B 2270/32

(57) ABSTRACT

A hydrogen generation system comprising a wind turbine rotor coupled to a generator, wherein the generator is electrically coupled to a DC-link by way of a primary power converter, the DC-link having a power dissipation element. The system also comprises a hydrogen electrolysis system coupled to the DC-link; an auxiliary power converter coupled to the DC-link; and one or more auxiliary loads. A control system controls the voltage on the DC-link to remain with a predetermined range. In one aspect, the system provides power to at least the auxiliary loads, in such a way as to manage the generation of hydrogen by the electrolyser whilst decoupling the performance of the electrolyser from varying wind conditions.

### TECHNICAL FIELD

The invention relates to a hydrogen electrolyser system that is powered by a wind turbine generator.

### BACKGROUND

It has long been known that hydrogen is a highly effective energy carrier which results in no CO₂ emissions when energy is released. It can be readily stored and transported making it a truly viable alternative to fossil fuels such as petrol and diesel. However, hydrogen production via water electrolysis, requires a tremendous amount of electricity thereby potentially reducing the positive environmental impact of moving to hydrogen fuel.

Hydrogen produced by renewable energy sources such as wind or solar power is the environmental ideal since no fossil fuels are used in its production. Hydrogen produced in this way is known as green hydrogen. However, because wind and solar power production is dependent on ever changing environmental conditions, it is difficult in practice to produce hydrogen efficiently from these power sources. One of the reasons for this is that when the power available to the electrolyser is low (such as below about 15% nominal load of the electrolyser) hydrogen can travel into the oxygen stream—a process known as hydrogen cross-over—which reduces efficiency and can present a safety issue.

A particularly efficient arrangement is to connect an electrolyser directly to the generator of a wind turbine generator in a DC-coupled connection. Such an arrangement can potentially provide many advantages in terms of lower cost due to the omission of a grid transformer and switchgear, and improved electrical efficiency as fewer power electronics need to be used. However, a major challenge to the DC-coupled concept is that the internal resistance of the electrolyser increases significantly when the voltage over the electrolyser is low. In this situation the current through the electrolyser will be drastically reduced and as a result the torque in the generator will drop significantly. As is well known in the art, sudden low generator torque is to be avoided as it leads to unbalanced loads, unwanted noise and improper control of rotor speed. This presents a large challenge to the DC-coupled concept at low wind turbine rotor speed.

It is against this background that the present invention has been developed.

### SUMMARY OF THE INVENTION

Against this background, the invention provides a hydrogen generation system comprising a wind turbine rotor coupled to a generator, wherein the generator is electrically coupled to a DC-link by way of a primary power converter, the DC-link having a power dissipation element.

The system also comprises a hydrogen electrolysis system coupled to the DC-link; an auxiliary power converter coupled to the DC-link; and one or more auxiliary loads. The auxiliary power converter comprises an energy storage system and is electrically coupled to the one or more auxiliary loads to provide operating power thereto. Furthermore, the system comprises a control system coupled to the auxiliary power converter, the primary power converter and the hydrogen electrolysis system, wherein the control system is configured to operate the auxiliary power converter, the primary power converter and the hydrogen electrolysis system to control the voltage on the DC-link to remain with a predetermined range.

An advantage of the invention is that the control system manages the primary power converter to provide power to the electrolysis system, and the auxiliary power converter to provide power to at least the auxiliary loads, in such a way as to optimise the generation of hydrogen by the electrolyser whilst decoupling the performance of the electrolyser from varying wind conditions. In this way, the power supplied to the electrolyser by the primary power converter can be regulated so that it is dependent, ie. Is a function of, the available wind power. The electrolyser can also be switchably controlled to vary the number of active cells within the electrolyser in dependence on the available wind power so as to maintain a narrow range of current density and thereby to optimise hydrogen production.

Further optional and advantageous features of the invention are described in the discussion that follows and are set out in the dependent claims.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described, by way of example only, with reference to the accompanying drawings, in which:

FIG. 1 is a schematic view of a wind turbine in which a hydrogen electrolysis system in accordance with the invention may be incorporated;

FIG. 2 is a schematic view of the of a hydrogen electrolysis system in accordance with an embodiment of the invention;

FIG. 3 is a schematic view which shows more details of an electrolyser of the hydrogen electrolysis system in FIG. 2;

FIG. 4 is a schematic view of a control system aspect of the hydrogen electrolysis system of the invention; and

FIG. 5 is a schematic view of another control system aspect of the hydrogen electrolysis system of the invention.

### DETAILED DESCRIPTION

The following detailed description refers to the accompanying drawings that show, by way of illustration, specific details and embodiments in which the invention may be practiced. These embodiments are described in sufficient detail to enable those of ordinary skill in the art to practice the invention. Other embodiments may be utilised, and structural changes may be made without departing from the scope of the invention as defined in the appended claims.

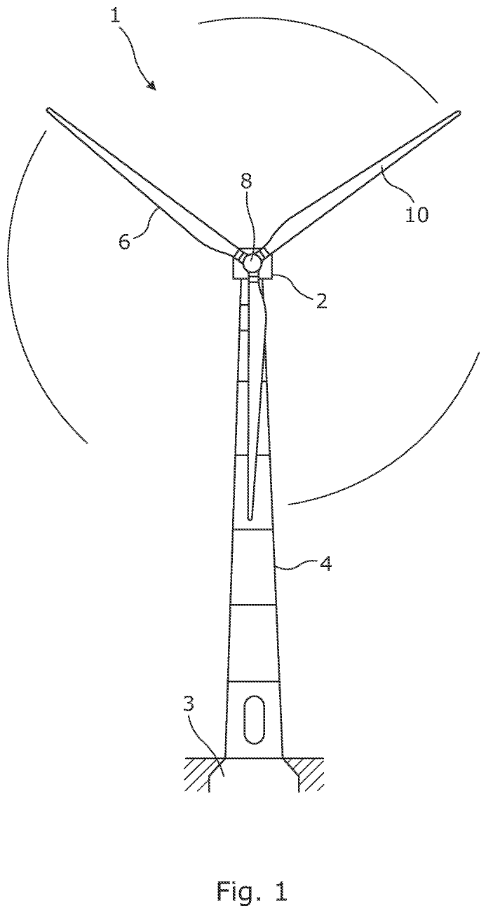

FIG. 1 shows a schematic view of a wind turbine 1 in which the invention may be incorporated. The wind turbine 1 includes a nacelle 2 that is supported on a generally vertical tower 4. The nacelle 2 supports a main rotor arrangement 6. The main rotor arrangement 6 comprises a hub 8 and a plurality of wind turbine blades 10 connected to the hub 8. In this example, the wind turbine 1 comprises three wind turbine blades 10. The wind turbine 1 in FIG. 1 is a well-known horizontal-axis wind turbine which is the most common form of large-scale wind turbine, but other formats would be acceptable for the invention.

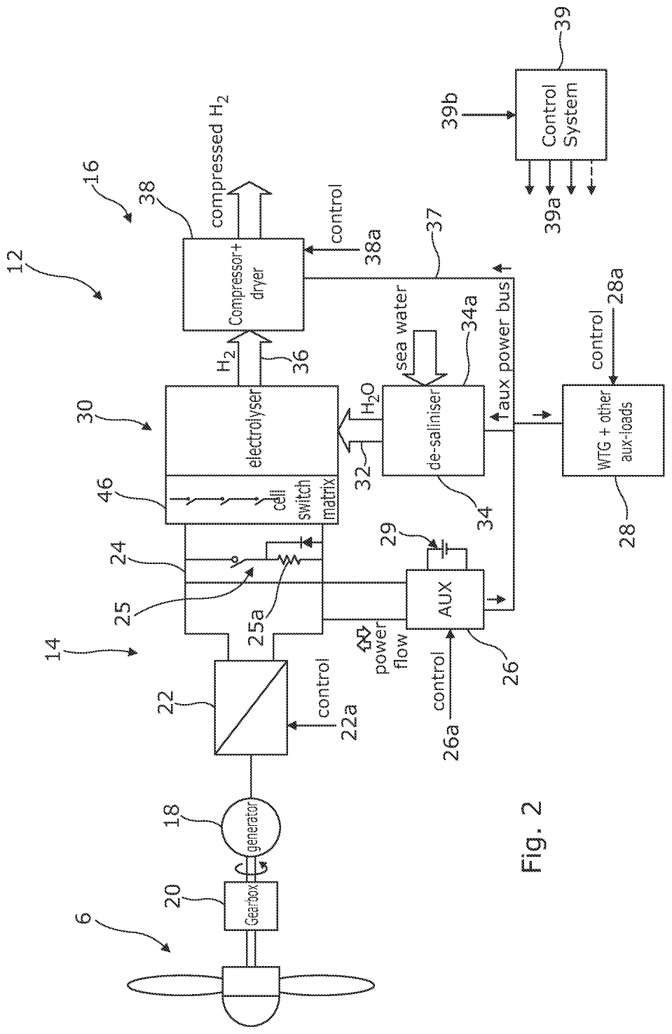

The nacelle 2 also houses many functional components of the wind turbine. Typically, such a wind turbine 2 would be used to generate electrical energy in AC or DC form for supply to an associated electrical distribution grid. However, in this embodiment of the invention the wind turbine 1 incorporates an integrated hydrogen generation system that uses the electrical power generated by a generator housed inside the nacelle 2 into stored energy in the form of hydrogen gas by an electrolysis system.

Whereas FIG. 1 illustrates a typical wind turbine in which the invention can be implemented, FIG. 2 shows a systems-level overview of a hydrogen generation system 12 in accordance with an embodiment of the invention.

In overview, the hydrogen generation system 12 comprises a power generation system 14 which is coupled to an electrolysis system 16.

The power generation system comprises the main rotor arrangement 6, hereinafter called simply the ‘rotor’, which drives an electrical generator 18 through a gearbox 20. It is to be noted that although a gearbox is a component that is typical in utility-scale wind turbine generators, systems are also known that are based on a so-called direct drive architecture which do not use a gearbox. The embodiments of the invention are applicable to both types of systems.

The generator 18 is electrically connected to a first or ‘primary’ power converter system 22. Typically, the generator 18 and the primary power converter system 22 would operate on a three-phase electrical architecture, although this is not essential.

The primary power converter system 22 provides a DC input power source to the electrolysis system 16 by way of a DC link 24. The skilled person would appreciate that the power primary converter system 22 and the DC link 24 in effect comprise half of what would usually be understood as a full-scale back-to-back power converter system architecture that is common in utility-scale wind turbines for the provision of variable frequency electrical power and associated reactive power support. However, in the system of the invention, only a single primary power converter system 22 is used to convert the AC power output by the generator 18 into DC power that is provided to the DC link 24 for supply to the electrolysis system 16. The electrolysis system 16 is therefore directly coupled to the primary power converter system 22 by the DC link 24. The precise form of converter implemented as the primary power converter system 22 would be within the capabilities of the skilled person. At a basic level the primary power converter system 22 may be implemented as a passive rectifier unit, which is preferably three-phase in in utility-scale applications. Such a rectifier may be implemented with suitable semi-conductor devices such as diodes and/or thyristors, or it may be implemented in a more sophisticated manner with transistor-based switching devices. The choice of current switching device such as diodes, thyristors and semi-conductor switches is within the capabilities of a skilled person.

As is usual with DC link based power systems, the DC link 24 is equipped with a power dissipation system 25, which may be referred to as a ‘chopper’. As would be understood by a skilled person, the power dissipation system 25 comprises a large resistance 25a that is switchable across the DC link with a variable duty cycle to as to provide the capability to dissipate a predetermined amount of energy from the DC link as heat in certain circumstances, with the aim of reducing the voltage of the DC link 24. Typically the power dissipation system 25 may be activated during power spikes/surges where excess energy is placed onto the DC link 24 before the rotor 6 is able to down-regulate the mechanical input power to the generator 18.

The power generation system 14 also comprises a second or ‘auxiliary’ power converter 26. The auxiliary power converter 26 is coupled to the DC link 24 and draws power from it in order to provide electrical power to other components of the hydrogen generation system 12 as well as to various other auxiliary loads and wind turbine sub-systems, as is represented by 28. Such auxiliary loads and sub-systems may be environmental conditioning systems, hydraulic systems, yaw systems, lighting systems, computing systems and so on, as would be within the understanding of a skilled person. As such, the auxiliary power converter 26 may be embodied as a DC-to-AC converter, preferably but not necessarily three-phase, which is configured to converter the DC voltage and current on the DC link 24 to alternating voltage and current for consumption by the various electrical loads connected to it.

The auxiliary power converter 26 is also configured to provide power support to the DC link 24 in various scenarios, as will become clear in this discussion. For this purpose, the auxiliary power converter 26 includes an electrical energy storage system 29 by which means the auxiliary power converter 26 is able to provide power damping functionality. The energy storage system 29 may be embodied by any suitable means, and for example may be a battery storage system or a fuel cell system. Beneficially, and as will be appreciated form the discussion that follows, the energy storage system 29 enables the auxiliary power converter 26 to provide power to the electrolyser 30 and the auxiliary loads 28 during wind conditions that are insufficient to generate enough power to run the electrolyser. The energy storage system 29 also enables the auxiliary power converter 26 to absorb excess power from the DC link 24 during transient conditions and in circumstances where they be a mismatch between the power that is absorbed/used/consumed by the electrolyser 30.

Turning to the electrolysis system 16 in more detail, in overview that system comprises an electrolysis cell stack or ‘electrolyser’ 30. The electrolyser 30 is fed with an input water stream 32 by a de-saliniser 34. The de-saliniser 34 is a known system that would be understood by the skilled person and so a full technical description will be omitted. The de-saliniser 34 constitutes a source of water which is particularly suited in an offshore setting because the de-saliniser 34 can draw water from the sea and provide purified water from the electrolyser 30. In principle an alternative water source such as a fresh-water tank or onshore pipe could be used, but in an offshore setting a de-saliniser is believed to be a convenient water to provide fresh water to the electrolyser 30.

The electrolyser 30 provides a hydrogen output stream 36 to a compressor 38 which also serves a drying function. In this embodiment, the electrolyser 30 is of the type to provide non-pressurised hydrogen, that is to say hydrogen at substantially atmospheric pressure, such that a compressor is required to pressurise the hydrogen output stream for usage and/or storage purposes.

It should be noted at this point however that as an alternative to the electrolyser 30 and the compressor 38, it is envisaged that an electrolyser operating at high pressure would be used, as would be understood by a skilled person.

It should be noted that the auxiliary power converter 26, the auxiliary loads 28, the de-saliniser 34 and the compressor 28 are all connected together by way of a power bus 37. The power bus 37 carries electrical power from the auxiliary power converter 26 to the other system components.

The hydrogen generation system 12 also comprises a control system 39. The control system 39 is shown here as a single functional block for simplicity, although it should be noted that this is not intended to infer any physical or logical restrictions on the actual implementation of the control system 39. As such, the control system 39 may be implemented as a standalone computing device which is configured to communicate via a wired or wireless connection with the systems, sub-systems, sensing units and so on under its control. The control system 39 may also be implemented as distributed control units, for example to provide redundancy. The precise physical and logical implementation of the control system 39 is not central to the invention. Rather it is the functionality provided by the control system 39 and as discussed herein that is of prime importance.

The control system 39 is provided with a plurality of control channels 39a to the following items: the primary power converter 22 (shown as control input 22a), the auxiliary power converter 26 (shown as control input 26a), the auxiliary loads 28 (shown as control input 28a), the electrolyser 30 (shown as control input 30a), the de-saliniser 34 (shown as control input 34a), and the compressor 38 (shown as control input 38a).

The respective control channels are configured to provide control commands to the relevant systems from the control system 39. The control channels are also configured to return sensing information to the control system 39 that it may need to perform its control objectives. The control system 39 is also configured to receive data input 39b from other sources. Such data input may include: pitch angle (β) of one or more blades of the rotor, rotational speed of the generator (w_g), wind speed (w_spd).

Notably, the control system 39 is coupled to the primary power converter 22, the auxiliary power converter 26 and the electrolysis system 16, and specifically the electrolyser 30, the de-saliniser 34, the compressor 38 to optimise operation of the hydrogen generation system 12. Specifically, the DC link 24 provides the capability to at least partially de-couple the operation of the electrolysis system 16 from the variable speed of the wind, and therefore the variable power generation. As will become apparent from the discussion that follows, the control system 39 is also able to supply power to the DC link 24 from the auxiliary power converter 26 in the event that available wind power drops such that the required DC link 24 voltage is not able to be maintained at required levels through operation of the primary power converter 22 alone. In summary, the control system 39 is configured to regulate the systems under its control to maintain a predetermined voltage on the DC link 24 despite a significant variation in the available wind power.

Before describing the functionality of the control system 39 in more detail, discussion will first focus on the structure of the electrolyser 30 for the benefit of the later discussion. It should be noted that in principle any suitable type of electrolyser 30 may be used, the specification of which would be within the understanding of a skilled person. However, in the illustrated embodiment the electrolyser includes structure and functionality which means that the number of active cells within the electrolyser 30 can be varied. This provides various advantages within the context of the invention which will become apparent in the discussion that follows.

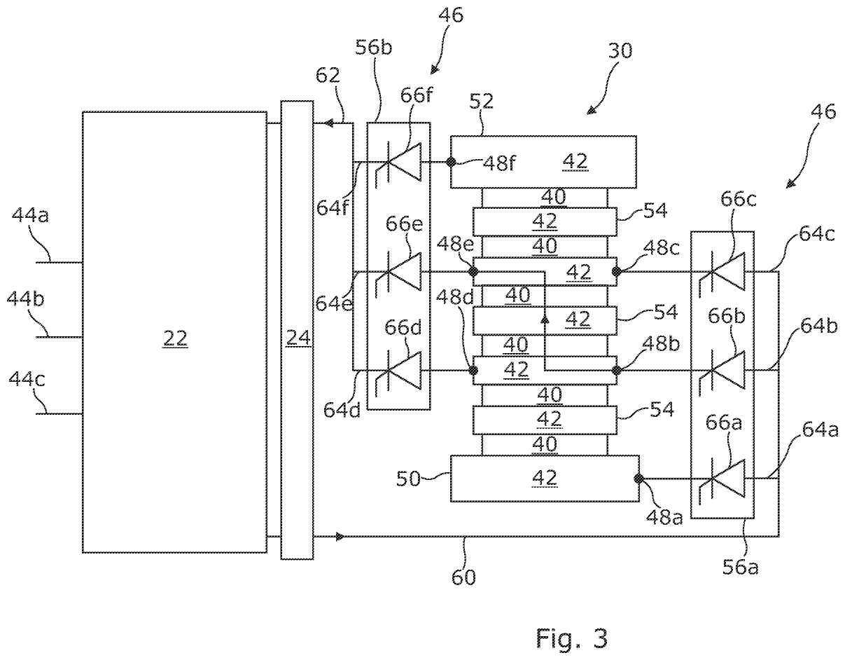

The electrolyser 30 is shown in more detail in FIG. 3, also in schematic form. With reference to FIG. 3, it can be seen that the electrolyser 30 comprises a plurality of electrolysis cells 40 arranged in a stack. Each of the electrolysis cells 40 comprises a pair of electrodes 42 for carrying electrical current to and from the electrolysis cells 40 in use. The electrodes 42 located between adjacent cells 40 in the stack may be electrically connected to one another via an intermediate electrical conductor so that current may flow in series between the cells 40 in the stack. Alternatively, the electrodes 42 located between adjacent cells 40 may abut one another or may be integral with one another. The electrodes 42 of adjacent cell 40 in the stack may therefore be referred to as being electrically adjacent. The electrolyser 30 may be any suitable type of electrolyser known in the art such as a PEM electrolyser or an alkaline electrolyser.

As can be seen in FIG. 3, the three phases of AC power produced by the generator are connected to the primary power converter 22 by respective electrical conductors 44a, 44b, 44c. The AC current from the generator is converted to DC current by the primary power convertor 24 and supplied to the DC link 24.

The primary power converter 22 is connected to the electrolyser 30 by way of a switching module 46. The switching module 46 is shown generally in FIG. 2 and in more detail in FIG. 3. For the purpose of this discussion, the switching module 46 may be considered to be part of the electrolyser 30. The switching module 46 has an appropriate structure and provides appropriate connections to operate cells 40 in the stack selectively. The switching module 46 will now be described in more detail.

The electrolyser 30 comprises a plurality of electrical connectors 48a, 48b, 48c, 48d, 48e, 48f which are connected to selected electrodes 42 of the electrolysis cells 40 forming the stack. The first electrical connector 48a is connected to the input electrode 42 of the electrolysis cell 40 located at a first end 50 of the electrolyser 30 and the sixth electrical connector 48f is connected to the output electrode 42 of the electrolysis cell 40 located at a second end 52 of the electrolyser 30.

The second and fourth electrical connectors 48b, 48d are connected to a first pair of electrically adjacent electrodes (which may be integral) part way along the stack of electrolysis cells 40, and the third and fifth electrical connectors 48c, 48e are connected to a second pair of electrically adjacent electrodes (which may be integral) a further part way along the stack of electrolysis cells 40. Thus, the electrolyser 30 may be split into three independently operable sections 54 depending on how the electrical connections to the electrolyser 30 are made.

In this embodiment the switching module 46 is embodied by two banks 56a, 56b of switches, which are illustrated as thyristors although the skilled person would appreciate that other switch means would be appropriate, for example other semiconductor switching devices such as MOSFETs, JFETs, IGBTs and so on. The DC link 24 is connected to the electrolyser 30 by way of the switching banks 56a,b.

The DC link 24 is connected across the electrolyser 30 by a pair of electrical conductors 60, 62. A first one of the pair of electrical conductors 60 is connected to the first switching bank 56a, which provides three selectively controlled branch electrical conductors 64a, 64b, 64c. Similarly, the second of the pair of electrical conductors 62 is connected to the second switching bank 56b which provides three selectively controlled branch electrical conductors 64d, 64e, 64f. Each of the branch electrical conductors 64a, 64b, 64c, 64d, 64e, 64f is selectively connectable to an electrode 42 of the electrolyser 30 via thyristors 66a, 66b, 66c, 66d, 66e, 66f.

The first branch conductor 64a is connected to the first electrical connector 48a via thyristor 66a. Similarly, the sixth branch conductor 64f is connected to the sixth electrical connector 48f via thyristor 66a. The second and fourth branch conductors 64b, 64d are connected to the second and fourth electrical connectors 48b, 48d via thyristors 66b, 66d respectively, and the third and fifth branch conductors 64c, 64e are connected to the third and fifth electrical connectors 48c, 48e via thyristors 66c, 66e respectively.

As is well known in the art, current may only pass through a thyristor when a small control current is applied to the gate of the thyristor. Thus, the thyristors 66a-f constitute electronic switches which selectively allow electrical connection of the branch conductors 64a-f to the electrical connectors 48a-f of the electrolyser 30. It is therefore possible to selectively operate different parts of the electrolyser 30 in dependence on the amount of power being provided by the generator as will be described in greater detail below.

For example, in use if the power provided by the generator 18 to the electrolyser 30 is at or above a first predetermined power output, e.g. 15%, of the rated maximum nominal load of the electrolyser 30, the entire length of the stack of electrolysis cells 40 forming the electrolyser 30 can be activated or ‘energised’. This is achieved by applying a control current to the gates of the first and sixth thyristors 66a, 66f to allow current to flow from the first end 50 to the second end 50 of the electrolyser 30 thereby utilising every electrolysis cell 40 in the stack. Alternatively, should the power available from the generator 18 be below 15% of the rated maximum nominal load of the electrolyser 30 the number of active electrolysis cells 40 can be reduced by selective operation of the thyristors 66a to 66f.

For example, if the power available from the generator 18 is less than the first predetermined power output (e.g. 15% as discussed above) but greater than or equal to a second predetermined power output (e.g. 10% of the rated maximum nominal load of the electrolyser 30) a control current may be applied to the gates of the first and fifth thyristors 66a, 66e to allow current to flow from the first end 50 through the first and second sections of the stack of cells 40, so that those activated cells experience a current flow above the threshold, even though the operating power is lower than the threshold of the whole electrolyser 30. Alternatively, a control current may be applied to the gates of the second and sixth thyristors 66b, 66f to allow current to flow through the second and third sections of the of the stack of cells 40 forming the electrolyser 30.

As another operational example, if the power available from the generator 18 is less than the second predetermined threshold, e.g. 10%, and greater than or equal to a cut-off minimum power of the rated maximum nominal load of the electrolyser 30, a control current may be applied to the gates of the first and fourth thyristors 66a, 66d to allow current to flow from the first end 50 through only the first section of the of the stack of cells 40. Alternatively, a control current may be applied to the gates of the second and fifth thyristors 66b, 66e to allow current to flow through only the second section of the of the stack of cells 40. In a further alternative, a control current may be applied to the gates of the third and sixth thyristors 66c, 66f to allow current to flow through only the third section of the of the stack of cells 40.

From the above discussion, therefore, it will be appreciated that the switching module 46 can be controlled to regulate the number of cells of the electrolyser 30 that are energised in dependence on various operational parameters—e.g. the power output of the generator or the power available from the wind—in order to maintain the electrolyser stack in a more efficient state of operation in which current density to the cells is controlled to maximise H2 production.

The choice of which section(s) of the electrolyser 30 to operate at any given time may be determined with reference to the usage history and/or a physical condition of the sections of the cells in the stack. For example, the section(s) of the electrolyser may be selected for operation with reference to the total operational time of the section(s) in question so that the total operational time is balanced between the available sections as far as possible. This helps to prolong the operative life of the electrolyser by preventing excessive wear in one or more sections of the electrolyser while leaving other sections relatively unused. If one or more sections of the electrolyser become worn it is necessary to replace the entire electrolyser 16. It is therefore desirable to distribute the total operational time between the various sections as evenly as possible.

Alternatively, or additionally, the choice of which section(s) of the electrolyser to operate at any given time may be determined with reference to a physical condition of the sections of the cells in the stack such as internal resistance. For example, the internal resistance of the sections of the electrolyser may be determined in real time or for example be determined via a database reference or based on modelling of the resistance and the section(s) with the lowest internal resistance selected. If this selection method is used in combination with the total usage time selection method, priority may be given to one or other of the methods, or an algorithm may be used to determine which section(s) 32 of the electrolyser to use at any given point in time.

It should be noted that operational control of the thyristors 66a-f is provided by the control system 39.

Having described the schematic overview of the hydrogen generation system 12 with reference to FIGS. 2 and 3, the discussion will now turn to specific functionality features of the control system 39 taken in context with the hydrogen generation system 12.

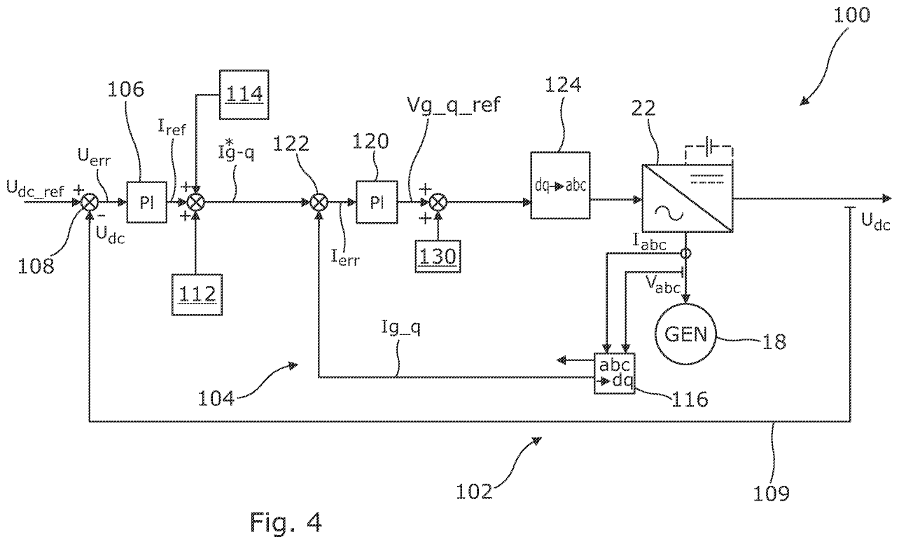

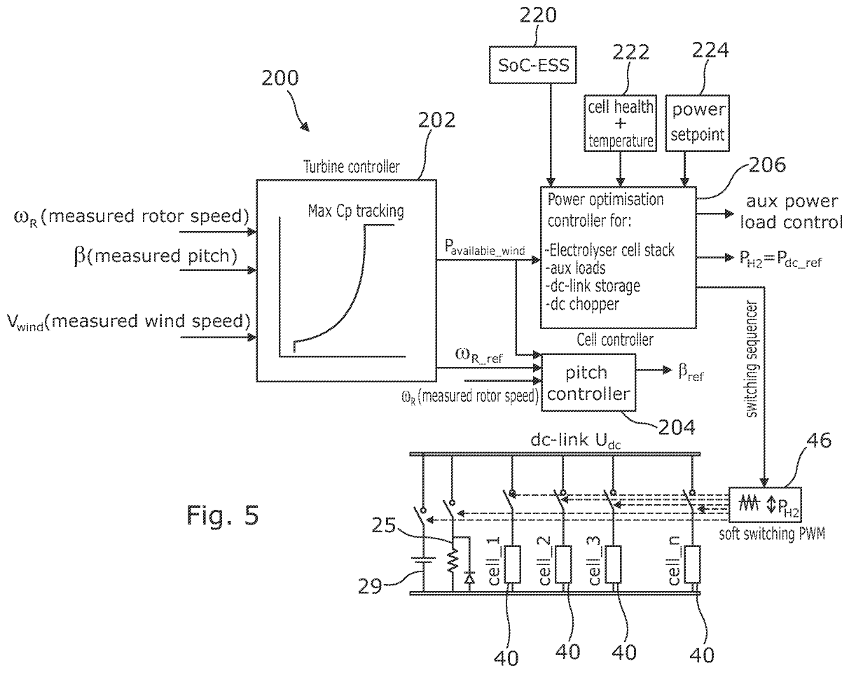

Two related control aspects are depicted in FIGS. 4 and 5 respectively. FIG. 4 illustrates a control scheme or algorithm 100 that is configured to control the voltage on the DC link 24 to a predetermined level, whereas FIG. 5 depicts a high-level control scheme 200 for controlling the cell activation for the electrolyser 30 by way of the switching module 46.

### FIG. 4—Outer Control Loop

Referring firstly to FIG. 4, the control scheme 100 includes an outer loop 102 and an inner loop 104. The outer loop 102 and the inner loop 104 function in a complementary way to control the voltage on the DC link 24 to a predetermined value, or within a range of that predetermined value. For example, the DC voltage may be allowed to vary in a range of 10% around a DC reference level in order to allow the generator to feed in a varying DC current to the electrolyser. A tighter range may be configured to more precisely control the DC voltage to a single value.

The role of the outer loop 102 is to minimise the error between a desired voltage on the DC link 24 and the actual or measured DC-link voltage. It does this by generating a current reference for controlling the primary power converter 22 in order to inject a required current onto the DC link 24 thereby to match the current supplied to the DC link with the current load on the DC link by virtue of the operation of the electrolyser 30, auxiliary loads 28, de-saliniser 34 and compressor 38.

To this end, the outer loop 102 comprises a first control module 106 which is configured to receive a voltage error value Uerr from summing junction 108. The first control module 106 outputs a current reference Iref. The current reference Iref is input into a second summing junction 110. The voltage error value Uerr is generated by summing junction 108 which subtracts a DC link voltage level Udc from a voltage reference level for the DC link 24, shown here as Udc_ref. The DC-link voltage level Udc is generated by measuring the voltage on the DC-link, and is shown here as a feedback loop 109 from the voltage output from the DC link.

The voltage reference value Udc_ref may suitably be generated by a pre-programmed setpoint value or look up table based on the available power from the wind. So the value Udc_ref may be generated as dependent at least on the available wind power but also factoring in other operational parameters.

The first control module 106 may be any suitable type of controller. It is shown here as a proportional-integral (PI) controller but may alternatively be embodied as a simple proportional controller or a proportional-integral-derivative (PID) controller, or other suitable controller type, as would be apparent to the skilled person. The derivation of controller gains would be within the capabilities of a skilled person.

In order to improve the accuracy of the first control module 106, second summing junction 110 also receives a feed forward signal component 112. That signal component 112 represents a predictive component that is proportional to the DC load and may be derived from foreknowledge of current and likely future operating conditions for the auxiliary loads and the electrolyser. Currently it is envisaged that the feedforward component provides an indication of the prevailing load current in the DQ reference frame thereby improving the DC-link load dynamics.

Additional predictive components can also be fed into the outer loop 102 at this point, as is represented by the signal component 114. For example, if damping systems responsible for drivetrain damping and tower oscillatory damping impose a power requirement on the DC link 24, then the signal component 114 may add a further contributing factor to the output Iref of the first control module 106. In summary, the signal component inputs 112, 114 adjust the current reference output of the first control module 106 in order to increase the torque current pulling the required power from the generator.

### FIG. 4—Inner Control Loop

The output of the first control module 106, shown here as Iref, is fed to the inner control loop 104 which comprises a second control module 120. The second control module 120 may be a PI controller in a similar way to the first control module 106 or any other suitable type of controller as would be well understood by the skilled person.

The function of the inner control loop 104 is to ensure that the current reference demanded of it by the outer control loop 102 is followed as closely as possible, thereby resulting in an accurate tracking of the DC link voltage, as well as fulfilling the actions of the feedforward components 112, 114.

Before the second control module 120, a third summing junction 122 calculates the error (Ierr) between the current reference Iref, and a feedback signal (labelled here as Ig_q) that represents the generator current in a DQ reference frame. More specifically, the generator current in this embodiment is the quadrature current related to the generator torque. Since the generator is a permanent magnet generator in this embodiment, the direct current component (d component) is zero because there is no current required to supply field windings.

The feedback signal Ig_q is derived by a measurement module 116 that measures the operational parameters of the generator and converts this to a rotating reference frame consistent with vector machine control, as would be well understood by the skilled person. This is achieved by way of a suitable transformation such as a Park transformation.

The output of the third summing junction 122 (Ierr) is therefore input into the second control module 120 which acts to provide an output signal Vg_q_ref, the purpose of which is to serve as an input command to the primary power converter 22 in order for it to drive the correct voltage on the DC link 24. The output signal Vg_q_ref may in some embodiments be input directly into the primary power converter 22 via a suitable inverse Park transformation module 124 in order to convert the signal from the DQ reference frame back to a three phase signal in the abc reference frame for the control of the primary power converter 22.

However, in this embodiment, the output signal Vg_q_ref from the second control module 120 is combined with a feedforward signal component 130 representing the back EMF of the generator in the DQ reference frame which improves dynamic performance.

In summary, therefore, the inner control loop 104 determines the current that is required to be fed onto the DC link 24 in order to reduce the voltage error that is calculated by the outer control loop 102. To this end, the outer loop 102 generates the voltage error signal Verr which the controller 106 attempts to reduce to zero by providing current control signal Ig_q. That current control signal is used to derived a torque current error Ierr, which is then used by the controller 120 to transform to a generator voltage command signal.?

Having described the operation of the control scheme 100 in FIG. 3 which is responsible for maintain the voltage on the DC link 24 at a predetermined value or within a predetermined range, the discussion will now turn to the second control scheme 200 as depicted in FIG. 5.

In a broad sense, the second control scheme has responsibility to manage efficiently the process of optimising the operation of the electrolyser 30 whilst balancing the loads on the DC link 24 during a variety of operational scenarios. Some examples operational examples are described below in more detail to provide a greater appreciation of the benefits of the invention.

In overview, the second control scheme 200 comprises a turbine control module 202, a pitch control module 204 and an electrolyser cell control module 206. Those control modules function in a complimentary manner to ensure that the individual cells of the electrolyser 30 are activated in dependence on the power available from the wind.

The functionality of the different control modules is as follows.

### Turbine Control Module 202

The turbine control module 202 is configured to calculate the power that is available from the wind during all wind conditions and, in combination with the pitch controller 204, regulates the rotational speed of the rotor 6 for optimal power control. In general, the turbine control module 202 is configured to i) calculate an available wind power signal, shown here as Pavail_wind, and ii) calculate an optimum rotor speed signal, shown here as ωr_ref, for maximising the generated power from the rotor 6. For this purpose, the turbine control module 202 receives at least three input signals relating to the turbine operational conditions: measured rotor speed ωr, measured pitch angle β, and measured wind speed Vwind.

The turbine control module 202 is therefore configured to output the available wind power signal, Pavail_wind, and the optimum rotor speed signal, ωr_ref, to the electrolyser cell control module 206.

### Pitch Control Module 204

Whereas the signals relating to available wind power Pavail_wind and optimum rotor speed, shown here as ωr_ref are calculated by the turbine control module 202, those signals are also input into the pitch control module 204 together with the measured rotor speed signal ωr. In turn, the pitch control module 204 calculates a pitch angle reference signal βref which is used to operate a pitch system (not shown) in a manner that would be understood by a skilled person.

Together, the turbine control module 202 and the pitch control module 204 function to optimise the generation of mechanical power of the rotor during partial and full load wind conditions.

Unusually, at part load operation, the pitch control module 204 is configured to control the pitch angle of the blades, by suitable setting of βref to maintain the rotor at a rotation speed that maximises power generation. This may be achieved with the use of a MPPT (maximum power point tracking) algorithm, as would be well understood by a skilled person.

At full load operation, as is detected when wind speed exceeds a full load wind speed threshold, the pitch control module 204 is operable to set βref to limit further power generation.

### Electrolyser Cell Control Module 206

In overview, the responsibility of the cell control module 206 is to ensure that the power consumed by the electrolyser 30 matches or follows the power generated by the generator 18 and the primary power converter 22. This results in the electrolyser 30 being operated as efficiently as possible in a variety of wind conditions.

More specifically, the cell control module 206 is configured to regulate the number of cells in the electrolyser 30 that are active, thereby using electricity to generate hydrogen gas, in dependence on the power that is available from the wind, at least in some wind conditions. This approach maximises the efficiency of hydrogen production by controlling the current density per cell of the electrolyser to minimise variation, and preferably to be approximately constant.

As can be seen from FIG. 5, the cell control module 206 receives several data inputs from various sources. In overview, the cell control module 206 receives the available wind power signal Pavail_wind from the turbine control module 204, a battery storage SoC signal 220 from the auxiliary power converter 26, a cell health signal 222 from the electrolyser 20 and a power setpoint signal 224. Note that the power setpoint signal 224 maybe a predetermined parameter that is set according to the rated power pf the wind turbine generator. For example, the generator 18 may have a rated power of 5MW, so this may be the standard power setpoint for the generator, or the predetermined value may be set to a lower value in dependence on the required rated power of the electrolyser 30.

Based on these signals, the cell control module 206 is configured to carry out at least one of a number of control functions.

A first example of such a control function is to control the operation of the electrolyser 30, and more specifically the switching state of the individual cells, or groups of cells, within the electrolyser 30. As the power available from the wind varies, the cell control module 206 is configured to be responsive to the available power and switch a number of the cells within the electrolyser to an active state in order to make efficient use of the generated power. The more active cells that are connected in parallel, the higher current level is drawn from the DC link 14.

The precise level of wind power that triggers operational changes may be configurable by appropriate means in the control system. For example, wind speed that represents minimum or ‘cut in’ power levels, part-load, full load, and intermediate power levels can be defined by an appropriate look up table. Data points in the look up table include power levels that relate wind power levels to activation and deactivation points for each cell or groups of cells in the electrolyser 30.

Other operating characteristics may also be factored into the operation of the cell control module 206. For example instead of or in addition to the available wind power, the cell control module 206 may also take into account the DC link voltage, the electrical loading of the auxiliary loads 28, the capacity of the energy storage system, the health and temperature of the electrolyser cells, and the external power setpoint.

In consideration of the above, therefore, the cell control module 206 may be configured with sophisticated decision algorithm for selecting one or more electrolyser cells for operation based on one or more of the above discussed operating parameters.

As can be seen in FIG. 5, the cell control module 206 is operably connected to the switching module 46, as is also depicted in FIGS. 2 and 3, in order to achieve selectable control over each cell in the electrolyser 30 if required. Other alternatives include that the switching module 46 has the capability to switch groups of cells between active and inactive states. It should be appreciated at this point that the electrolyser cells 40 are shown as directly connected between the bars of the DC link 40. This is for illustrative convenience only and does not imply a particular structural limitation on the form of the electrolyser 30, as has already been described above with reference to FIG. 3.

In switching the cells between active (conductive) and inactive (non-conductive states), the switching module 46 may operate on a ‘soft switching’ principle in which the cell or cells in question are switched between an inactive state and an active state more gradually than would otherwise be the case with a simple electronically controlled two-state switch. For this purpose, the switching module 46 may therefore be configured to implement a pulse-width modulated switching approach in which the cells of the electrolyser 30 are controlled via a switching signal that may be varied between an inactive state, with a 0% duty cycle, and an active state, with a 100% duty cycle. Each of the cell switches (see thyristors 66a-f in FIG. 3) may therefore ramp up between inactive and active states by increasing the duty cycle between 0% and 100% over a predetermined time period.

It is currently envisaged that a suitable time period in which to ramp up the switching state of an electrolyser cell would be in the range of 1 to 4 seconds. It should be noted, however, that the precise time period depents on the requirements of the cell stack, the period of typical wind variations, and the DC link load characteristics.

The benefit of switching the electrolyser cells between inactive and active state with the use of variable duty cycle means that sharp changes in the DC link load current can be avoided, which thereby also avoids unwanted voltage spikes which may affect converter operation.

Optionally the switching module 46 may also be used to control the operation of the power dissipation system 25 associated with the DC link 24 and also the energy storage system 29 associated with the auxiliary power converter 26. It should be noted that the power dissipation system 25 and the energy storage system 29 are shown here as being controlled by way of the switching module 46, which provides a convenient central control under the main control system 39. However, it is envisaged that they may also be controlled separately.

A further example of a control function carried out by the cell control module 206 is as follows. The cell control module 206 may be configured to be responsive to wind conditions where there is very low wind speed or even zero wind speed. In such circumstances, the turbine controller 202 would set the available wind power signal Pavail_wind to a value that is below a predetermined threshold. In response, the cell control module 206 is operable to disconnect all of the cells of the electrolyser 30 from the DC-link 24 thereby in effect disabling the electrolyser 30 so that it does not produce hydrogen. Therefore, if wind speeds are below a minimum level, which is often known as the ‘cut in’ wind speed, the cell control module 206 may be configured to disconnect the electrolyser 30 from the DC link 24. This stops the power draw from the DC link 24 due to the electrolyser 30

In such wind conditions, the generator 18 is not generating power, so this compromises the ability of the primary power converter 22 to supply to DC link 24 with sufficient power to operate the auxiliary loads 28. Therefore, to address this issue the cell control module 206 is operable to control the auxiliary power converter 26 to supply the DC link 24 with sufficient energy in order to maintain the voltage on the DC link 24 in an acceptable range so that it is able to continue to supply the auxiliary loads 28 with power. The DC link voltage may therefore be maintained by the energy storage system 29 as fed by the auxiliary power converter 26 for the duration in which sufficient capacity remains on the energy storage system 29, which may between 48 and 60 hours, depending on the capacity of the energy storage system 29.

Since the energy in the storage system 25 is finite, the cell control module 206 may be configured to monitor the SoC of the energy storage system 25 in order to determine when the SoC is insufficient to maintain the voltage on the DC-link 24.

For longer periods of insufficient wind, the cell module controller 206 may be operable to take action so as to reduce the electrical auxiliary loads to a minimum so as to reduce the discharge rate on the energy storage system. This may be referred to as ‘standby’ or ‘sleep’ mode. The reduced auxiliary loads may be maintained at a minimum level for a predetermined period—for example between 20 and 40 hours or more. The pre-determined period may be set as required within the system, or it may be based on the measured SoC of the energy storage system 25.

The transition to sleep mode of the auxiliary loads 28 may be based on the cell control module 206 acting on a measured predetermined SoC level of the energy storage system 25. For example, the cell control module 206 may be configured to trigger the auxiliary loads to sleep mode when it detects that the energy storage system SoC has dropped to 30%. The precise value is not crucial and will depend on the electrical characteristics of the energy storage system 29 and other factors such as a safety margin which should be included for the energy storage system 29 to maintain sleep mode for a required period of time.

Operational scenarios may also include a situation where the control system is interrupted by an external safety system, or from a watchdog alert system for the primary power converter 22, which can be considered to be a trip of the system. The cell module controller 206 may be configured to recognise a system trip/failure by [tbc]. In response, the cell module controller 206 may be configured to take appropriate safety action by configuring the system to protect the electrolyser 30 and switch to essential electrical loads only. For example, the cell control module 206 may command the primary power converter 22 to halt operation by suspending PWM control signals, and to open the relevant circuit breakers (not shown), to disconnect the electrolyser 30, and to switch the auxiliary loads 28 to sleep mode so as to be powered by the auxiliary power converter 26 using energy from the energy storage system 29. To dissipate excess generated power on the DC link 24, the cell control module 206 may also be configured to operate the power dissipation system 29.

The above exemplary scenarios provide examples of the system response when the wind speed drops to low levels such that efficient operation of the electrolyser 30 cannot be supported.

Usually, however, wind speed dwell periods are temporary. Therefore, the cell control module 206 is operable to monitor the wind speed, via the available wind power signal Pavail_wind, and halt the operation of the auxiliary power converter when sufficient wind power is once again available and to reset the subsystems to their nominal operational states. Therefore, once the wind speed increases to acceptable levels, as is detected by the turbine control module 202, the pitch angle of the blades can be moved to an appropriate pitch angle for power production, whilst the cell control module 206 takes appropriate action to bring the electrolyser 30 into operation by turning selected ones of the cells into an active state. During this part-load operation, in which wind speed is above a minimum level but below a full load level, the cell controller 206 will be operable to match the number of active cells 40 in the electrolyser 30 to the power available in the wind so as to optimise the hydrogen generation efficiency of the electrolyser 30.

At full load operation, wind speed is such that the turbine control module 204 controls the pitch angle of the blades so as to limit the power generation of the rotor to a set value, as is shown in FIG. 5. In such a scenario, one option is for the cell control module 206 to control the electrolyser 30 that that all cells 40 are active and thereby generating hydrogen. However, in an alternative approach to full-load operation, the cell control module 206 may maintain a selected number of cells as inactive even during full-load operation. Such inactive cells can be brought into operation during transient events such as wind gusts where it may be necessary to absorb an amount of excess power from the DC link 24. It may therefore be preferable to activate the ‘reserve cells’ during short period of excess transient power rather than operate the power dissipation system 25. The so called ‘reserve cells’ may also be useful in the event of failure of other cells in the stack so as to provide a degree of redundancy and therefore prolong the service life of the stack and reduce mean time between failure.

The system of the invention provides further operational flexibility through the use of the energy storage system 29 during full load operation. In such circumstances, the cell control module 206 may be configured to monitor the available wind power under current conditions and detect when excess power is available. This may be because of a sustained period of elevated wind speed, or a relatively short gust of wind. In response, the cell control module 206 may be configured to operate the auxiliary power converter 26 so that the energy storage system absorbs electrical energy from the DC link 24 when it is determined that power available from the wind is greater than a predetermined value thereby avoiding a rise in voltage on the DC link 24. The predetermined wind power may be determined in various ways and is linked to the wind power that is required to maintain the DC link voltage at a voltage level sufficient to ensure efficient operation of the electrolyser 30 and, optionally, to ensure that the energy storage system 29 is maintained to a predetermined capacity, e.g. 70% SoC, which allows some headroom for transient power absorption if the available power is predicted to increase above that pre-determined value, then the cell control module 206 can take the necessary action to command excess generated power to be absorbed by the energy storage system 29 as described above. Further thresholds may be put in place to trigger other actions, such as operation of the power dissipation system 25.

In another alternative, the cell control module 206 may be configured to use the power on the DC link 245 to apply a breaking force to the rotor by way of the primary power converter 22. In this way, the inertia of the rotor 6 in effect absorbs electrical energy from the DC link 24 by the application of the applied braking force through the generator.

Advantageously, therefore, the energy storage system 29 together with the auxiliary power converter 26 can be used as an electrical damping means to absorb excess energy from the DC link or supply energy to the DC link in various scenarios thereby to increase the capability of the control system to maintain the DC link voltage within an acceptable range for efficient operation of the electrolyser 30.

The magnitude of the available power from the wind may be determinative over which system is selected to absorb power from the DC link 24. Therefore, the selection of which energy absorption system (e.g. power dissipation system 25, energy storage system 29, electrolyser cells 40, main rotor 6) may be dependent on or to be a function of the available wind power. In principle, the energy storage system 29 may be configured automatically to draw current as required from the DC link 24 during operation in order to maintain a threshold SoC, whilst maintaining a suitable SoC headroom so as to be able to absorb power spikes. The energy storage system 29 therefore becomes the first piece of equipment to provide power absorption and supply damping. If the energy storage system 29 does not have capacity to absorb further power, then the power dissipation system 25 may be identified as the second priority system to absorb excess power from the DC link 24 because it is fast acting and can dissipate large amounts of power as heat. A lower priority power absorption function is the inertia of the rotor 6, as discussed above.

In the above discussion, various embodiments and operational scenarios have been discussed within the scope of the inventive concept. The skilled person would understand, however, that over variants would be possible without departing from the inventive concept as defined by the claims.

1. A hydrogen generation system comprising:
a wind turbine rotor coupled to a generator,
wherein the generator is electrically coupled to a DC-link by way of a primary power converter, the DC-link having a power dissipation element;
a hydrogen electrolysis system coupled to the DC-link;
an auxiliary power converter coupled to the DC-link;
one or more auxiliary loads,
wherein the auxiliary power converter is electrically coupled to the one or more auxiliary loads to provide operating power thereto;
and wherein the auxiliary power converter comprises an energy storage system;
a control system coupled to the auxiliary power converter, the primary power converter and the hydrogen electrolysis system, wherein the control system is configured to operate the auxiliary power converter, the primary power converter and the hydrogen electrolysis system to control the voltage on the DC-link to remain with a predetermined range.

2. The system of claim 1, wherein the control system is configured to control the auxiliary power converter so that the energy storage system absorbs electrical energy from the DC link when the control system determines that power available from the wind is greater than a predetermined value thereby avoiding a rise in voltage on the DC link.

3. The system of claim 1, wherein the control system is configured to control the auxiliary power converter so that the energy storage system provides electrical energy to the DC link when the control system determines that the power available from the wind is less than a predetermined value, thereby avoiding a drop in voltage on the DC link.

4. The system of claim 1, wherein the wind turbine rotor comprises a pitch system to control the pitch of blades associated with the wind turbine rotor, wherein the control system is operatively coupled to the pitch system so as to control the rotational speed of the rotor, in use, by varying blade pitch.

5. The system of claim 4, wherein the control system controls the rotational speed by varying blade pitch during partial load operation.

6. The system of claim 1, wherein the hydrogen electrolysis system further comprises:
a plurality of electrolysis cells arranged in one or more stacks, wherein each electrolysis cell comprises a pair of electrodes, and wherein each stack of electrolysis cells comprises at a plurality of electrical connectors each of which is in electrical contact with an electrode of an electrolysis cell,
wherein the electrical connectors are electrically connectable to the DC-link by a network of selectively operable electrical conductors which are configured so that some or all of the electrolysis cells are operable in dependence on the operative condition of the selectively operable electrical conductors.

7. The system of claim 6, wherein the electrical connectors of at least one stack of electrolysis cells are configured so that electrical current may enter the stack at a plurality of locations.

8. The system of claim 6, wherein the electrical connectors of at least one stack of electrolysis cells are configured so that electrical current may exit the stack at a plurality of locations.

9. The system of claim 6, wherein the control system is configured to control the selectively operable electrical conductors to enable all of the electrolysis cells when a monitored one or more operating characteristic is within a predetermined range of operation, and to enable only a portion of the electrolysis cells when the monitored operating characteristic is outside of the predetermined range of operation.

10. The system of claim 9, wherein the monitored operating characteristic is at least one of:
i) available wind power;
ii) DC-link voltage;
iii) auxiliary loads, and
iv) energy storage system capacity
v) electrolyser cell health
vi) electrolyser cell temperature.

11. The system of claim 6, wherein the selectively operable electrical conductors are controlled by respective pulse width modulation (PWM) control signals.

12. The system of claim 11, wherein the PWM control signal for each a respective selectively operable conductor has a controllable duty cycle.

13. The system of claim 12, wherein for each selectively operable conductor, the PWM control signal is ramped from a first duty cycle to a second duty cycle in order to change the operating state of the selectively operable conductor so as to reduce current spikes.

14. The system of claim 6, wherein the network of selectively operable electrical conductors are configured so that some or all of the electrolysis cells are connectable in series or parallel.

15. The system of claim 1, wherein the control system is further configured to monitor an available power parameter, representing the power available from the current wind conditions, and to monitor the total electrical load of the hydrogen electrolysis system and the one or more auxiliary loads, and is further configured to control at least one of the following systems for excess power absorption in the event that the available power parameter exceeds the total electrical load: the wind turbine rotor, the power dissipation element associated with the DC-link and the energy storage system.

16. The system of claim 15, wherein the control system is configured to detect the magnitude of available power, and select the system for excess power absorption in dependence on the magnitude of the available power.

17. The system of claim 1, wherein the control system is further configured to detect wind speed falling below a predetermined minimum wind speed, and to carry out the following control actions: i) disable operation of the hydrogen electrolyser system, and ii) operate the energy storage system to provide power to the one or more auxiliary loads.

18. The system of claim 17, wherein the control system is further configured to control the one or more auxiliary loads to reduce power requirement therefrom.

19. The system of claim 18, wherein the control system controls the one or more auxiliary loads to reduce the power requirement therefrom in dependence on wind forecast data.

20. The system of claim 1, wherein the control system is configured to control the power dissipation element to dissipate excess electrical energy from the DC link in the event that a voltage surge on the DC-link is detected.

21. The system of claim 1, wherein the energy storage system includes at least one of a battery storage system and a fuel cell system.
